(19) United States
(12) Patent Application Publication
(10) Pub. No.: US 2010/0161452 A1
(43) Pub. Date: Jun. 24, 2010

(54) COMPUTER SYSTEM AND METHOD FOR CALCULATING LIMIT NUMBER OF DISPLAYED COMMODITIES

(75) Inventors: Akio Hiruma, Tokyo (JP); Kenya Hiramatsu, Tokyo (JP); Kenji Shimizu, Tokyo (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/640,651

(22) Filed: Dec. 17, 2009

(30) Foreign Application Priority Data
Dec. 22, 2008 (JP) 2008-325165

(51) Int. Cl. G06Q 10/00

(52) U.S. Cl. 705/28

(57) ABSTRACT

In order to easily calculate a maximum number of commodities that can be displayed in a display space on a display shelf, a computer system executes: processing for dividing space width of a display space specified by a space code by commodity width of a commodity specified by a commodity code to calculate a width direction number of commodities that can be displayed in a width direction of the display space; processing for dividing space depth of the display space specified by the space code by commodity depth of the commodity specified by the commodity code to calculate a depth direction number of commodities that can be displayed in a depth direction of the display space; and processing for multiplying together the width direction number of commodities and the depth direction number of commodities to calculate a limit number of displayed commodities.

### CROSS-REFERENCE TO RELATED APPLICATION

This application claims the benefit of priority from Japanese Patent Application No. 2008-325165 filed on Dec. 22, 2008, the entire content of which is incorporated herein by reference.

### TECHNICAL FIELD

The present invention relates to a computer system and a method for calculating a maximum number of commodities that can be displayed in a display space on a display shelf set in a store (i.e., a limit number of displayed commodities).

### BACKGROUND

There is known a system for totaling the number of commodities displayed on a display shelf set in a retail store. For example, in an electronic inventory tag system disclosed in JP-A-2007-206745, a store clerk reads identification information from commodity IC tags attached to respective commodities using a tag reader. The electronic inventory tag system totals the number of commodities on the basis of the read identification information.

It is possible to total the number of commodities displayed on a display shelf by using the technique disclosed in JP-A-2007-206745. Further, it is possible to construct a system that causes a reporting terminal to perform reporting operation when the number of commodities decreases to be equal to or smaller than a fixed number as customers purchase commodities from the display shelf. Therefore, when this system is used, the store clerk only has to carry commodities to the display shelf and display the commodities according to the reporting operation of the reporting terminal.

However, in this system, what matters is how many commodities the store clerk should carry to the display shelf. A frequency of insufficiency of commodities on the display shelf is reduced by supplying as many commodities as possible in the display space on the display shelf. As a result, the store clerk can reduce the number of times of commodity supply work. However, if the store clerk carries too many commodities to the display shelf, the store clerk has to return commodities that cannot be displayed in the display space to a warehouse or the like. Therefore, a maximum number of commodities that can be displayed in the display space is important information. However, the store clerk can grasp the maximum number of commodities that can be displayed on the display shelf only when the store clerk actually displays commodities in the display space on the display shelf. In other words, the store clerk does not know how many commodities the store clerk should carry to the display shelf when the reporting terminal performs the reporting operation. JP-A-2007-206745 does not include a description that takes this point into account.

### SUMMARY

It is an object of the present invention to provide a computer system and a method that can easily calculate a maximum number of commodities that can be displayed in a display space on a display shelf.

Therefore, a computer system according to an aspect of the present invention includes: an input unit for inputting information; a display unit for displaying the information; a space-size storing unit for storing, in association with a space code for specifying a display space, size information of the display space; a commodity-size storing unit for storing, in association with a commodity code for specifying a commodity, size information of the commodity; and an information processing unit configured to execute processing for dividing space width of a display space, the space width of a display space being specified by a space code input from the input unit and being acquired from the space-size storing unit, by commodity width of a commodity, the commodity width of a commodity being specified by a commodity code input from the input unit and being acquired from the commodity-size storing unit, to calculate a width direction number of commodities that can be displayed in a width direction of the display space, processing for dividing space depth of the display space, the space depth of the display space being specified by the input space code and being acquired from the space-size storing unit, by commodity depth of the commodity, the commodity depth of the commodity being specified by the input commodity code and being acquired from the commodity-size storing unit, to calculate a depth direction number of commodities that can be displayed in a depth direction of the display space, processing for multiplying together the width direction number of commodities and the depth direction number of commodities to calculate a limit number of displayed commodities, and processing for displaying the limit number of displayed commodities on the display unit.

According to another aspect of the present invention, there is provided a method carried out by a computer system, the method including: storing, in association with a space code for specifying a display space, size information of the display space in a space-size storing unit; storing, in association with a commodity code for specifying a commodity, size information of the commodity in a commodity-size storing unit; dividing space width of a display space, the space width of a display space being specified by a space code input from an input unit and being acquired from the space-size storing unit, by commodity width of a commodity, the commodity width of a commodity being specified by a commodity code input from the input unit and being acquired from the commodity-size storing unit, to calculate a width direction number of commodities that can be displayed in a width direction of the display space; dividing space depth of the display space, the space depth of the display space being specified by the input space code and being acquired from the space-size storing unit, by commodity depth of the commodity, the commodity depth of the commodity being specified by the input commodity code and being acquired from the commodity-size storing unit, to calculate a depth direction number of commodities that can be displayed in a depth direction of the display space; and multiplying together the width direction number of commodities and the depth direction number of commodities to calculate a limit number of displayed commodities.

According to the aspects of the present invention, it is possible to easily calculate a maximum number of commodities that can be displayed in a display space on a display shelf (i.e. a limit number of displayed commodities) by performing only operation for inputting a space code and a commodity code. Therefore, a store clerk only has to perform work for supplying commodities equivalent to the limit number of displayed commodities. As a result, efficiency of display work is attained.

### DESCRIPTION OF THE DRAWINGS

FIG. 1 is a schematic diagram of an overall computer system configured to calculate a limit number of displayed commodities;

FIG. 2 is a schematic perspective view of a display shelf;

FIG. 3 is a schematic perspective view of a commodity;

FIG. 4 is a block diagram of the electric configuration of the computer system configured to calculate the limit number of displayed commodities;

FIGS. 5A to 5C are schematic diagrams of the structure of a database;

FIG. 6 is a flowchart of a flow of processing for calculating the limit number of displayed commodities;

FIG. 7 is a schematic diagram of an example of an input screen displayed on an input screen of a PDA terminal; and

FIG. 8 is a flowchart of a flow of processing for deciding the limit number of displayed commodities.

### DETAILED DESCRIPTION

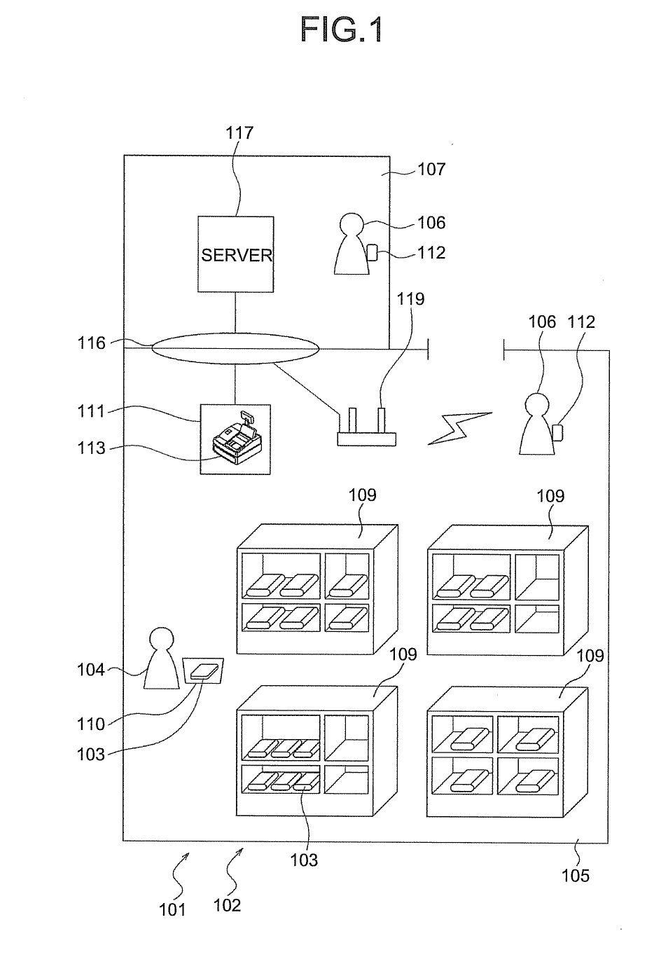

An embodiment of the present invention is explained below with reference to FIGS. 1 to 8.

FIG. 1 is a schematic diagram of an overall computer system 101 for calculating a limit number of displayed commodities (hereinafter referred to as computer system 101). The computer system 101 is installed in, for example, a supermarket 102. The supermarket 102 is sectioned into a selling floor space 105 and a backyard 107. The selling floor space 105 is a space where a customer 104 purchases commodities. The backyard 107 is a space where only a store clerk 106 is allowed to enter. In an example shown in FIG. 1, there are four display shelves 109 in the selling floor space 105. Shelf specifying signs for uniquely specifying the respective display shelves 109 are allocated to the display shelves 109. Various commodities 103 are displayed on the display shelves 109. Barcodes (not shown) are attached to all the commodities 103. The barcodes are obtained by symbolizing commodity codes of the commodities 103.

In the supermarket 102, the customer 104 puts a commodity 103 that the customer 104 is about to purchase in a shopping basket 110. The customer 104 goes to a register area 111 for checkout. The store clerk 106 guides the customer 104 and performs commodity display work in the selling floor space 105. The store clerk 106 also performs stock check work in the backyard 107. In order to perform checkout transaction work for the commodity 103 purchased by the customer 104, the store clerk 106 operates a POS terminal 113 present in the register area 111 of the selling floor space 105. The POS terminal 113 includes a barcode scanner (not shown) configured to decode a read barcode into a commodity code. The POS terminal 113 calculates, in the checkout transaction, a checkout amount on the basis of the commodity code decoded from the read barcode. The POS terminal 113 transmits sales information to a server 117 (explained later). All POS terminals 113 are connected to a LAN 116 disposed in the supermarket 102. The server 117 and a radio access point 119 set in the backyard 107 are also connected to the LAN 116. The radio access point 119 configures a radio communication unit for the server 117 to transmit and receive radio signals. As an example, the radio access point 119 is installed on the ceiling (not shown) of the selling floor space 105. The store clerk 106 carries a PDA terminal 112 during a job. The server 117 performs radio communication with the PDA terminal 112 as a reporting terminal via the radio access point 119.

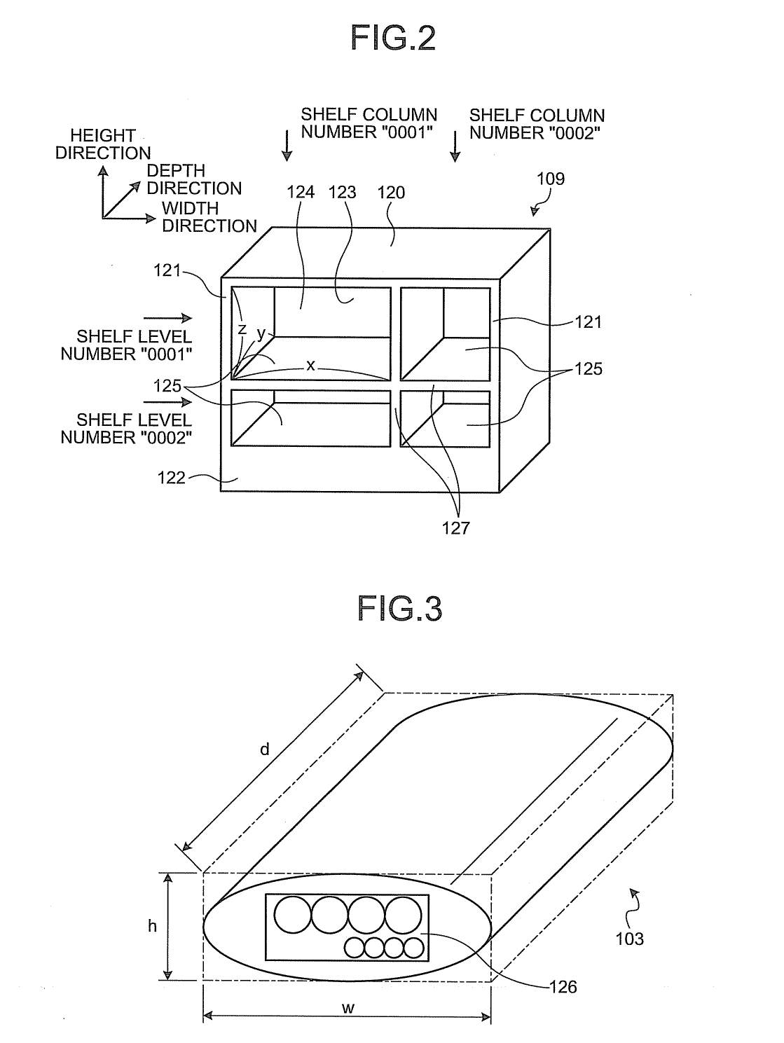

FIG. 2 is a schematic perspective view of the display shelf 109. An internal space 124 of a substantially rectangular parallelepiped shape is formed in the display shelf 109 by a top plate 120, side plates 121, a bottom member 122, and a back plate 123. The internal space 124 is partitioned by partitioning members 127 provided in parallel to the top plate 120 and the side plates 121, respectively. As a result, display spaces 125 in two levels and two rows are formed in the display shelf 109. In FIG. 2, a shelf level number “0001” is allocated to two display spaces 125 located on the upper side. A shelf level number “0002” is allocated to the remaining two display spaces 125 located on the lower side. A shelf column number “0001” is allocated to two display spaces 125 located on the left side. A shelf column number “0002” is allocated to the remaining two display spaces 125 located on the right side.

FIG. 3 is a schematic perspective view of the commodity 103. A commodity name indication 126 is attached to the commodity 103. The commodity name indication 126 indicates a surface directed to a front direction when the commodity 103 is displayed in the display space 125 on the display shelf 109. In this specification, the length in the horizontal direction of the commodity 103 viewed from a side on which the commodity name indication 126 is attached is referred to as commodity width w. The length in the height direction is referred to as commodity height h. The length in the depth direction is referred to as commodity depth d.

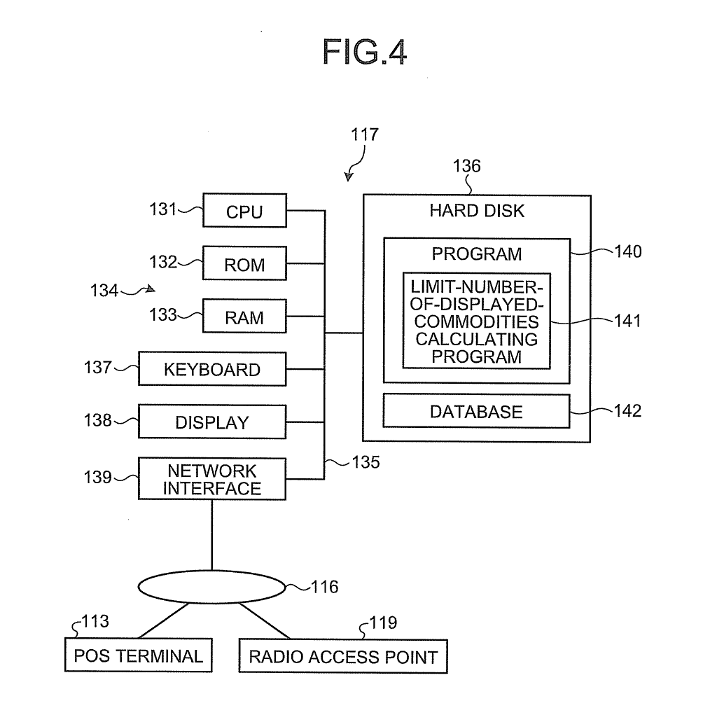

FIG. 4 is a block diagram of the electric configuration of the computer system 101. The server 117 includes an information processing unit 134 including a CPU 131, a ROM 132, and a RAM 133. The information processing unit 134 is connected to a hard disk 136, a keyboard 137, a display 138, and a network interface 139 via a bus line 135. The network interface 139 realizes data communication between the server 117 and other apparatuses connected to the LAN 116.

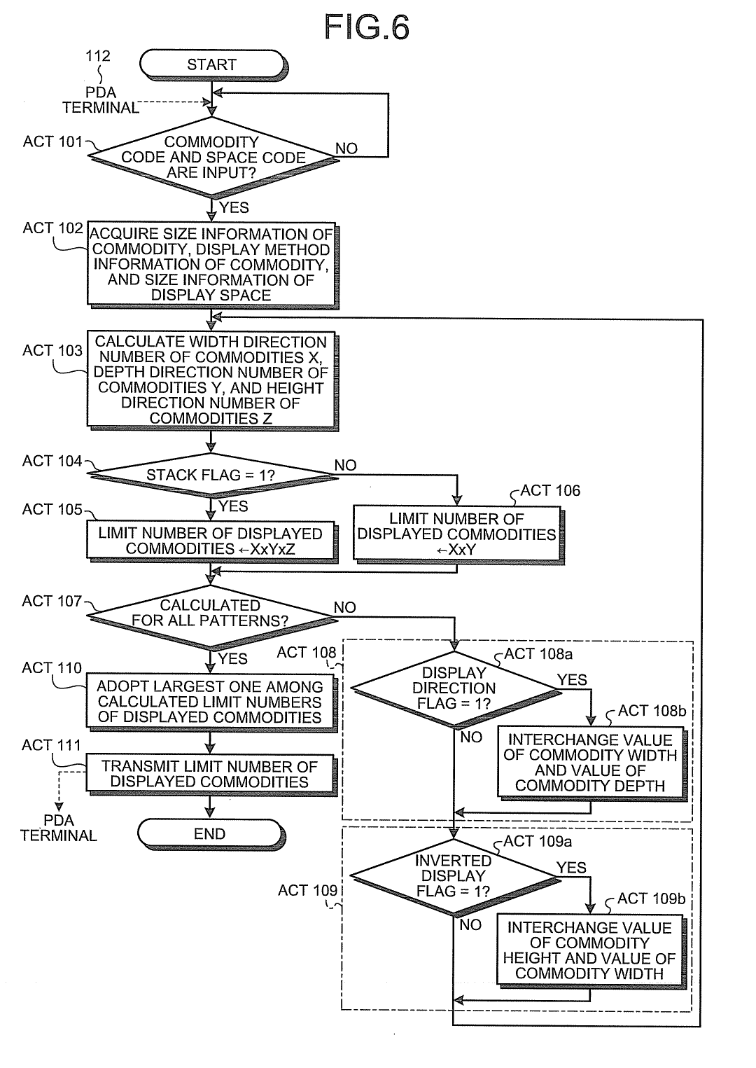

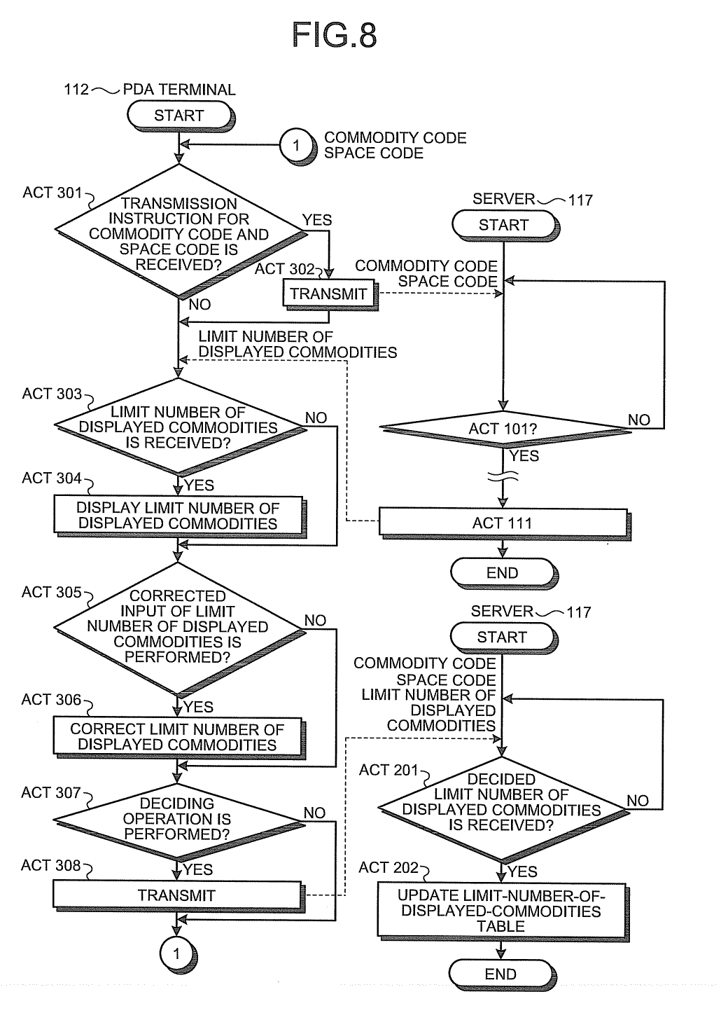

The hard disk 136 stores a computer program 140 for causing the CPU 131 to realize various kinds of information processing and a database 142. The computer program 140 includes a computer program for calculating a limit number of displayed commodities (a limit-number-of-displayed-commodities calculating program) 141 for causing the CPU 131 to realize processing shown in FIGS. 6 and 8. Besides, the computer program 140 includes an OS and a driver program. The CPU 131 copies the entire computer program 140 or a part of the computer program 140 to the RAM 133 during the start of the server 117. Subsequently, the CPU 131 executes processing corresponding to description content of the computer program 140.

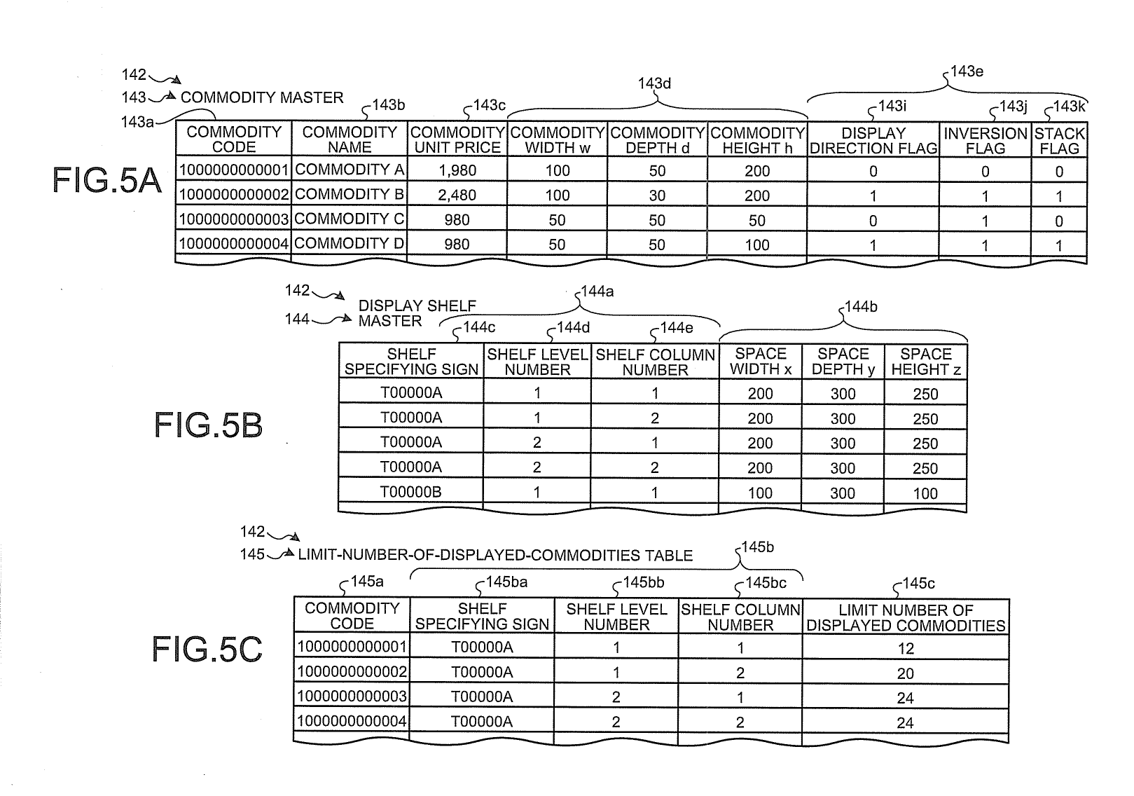

FIGS. 5A to 5C are schematic diagrams of the structure of the database 142. The database 142 stores a commodity master 143, a display shelf master 144, and a limit-number-of-displayed-commodities table 145.

The commodity master 143 (FIG. 5A) stores a commodity code 143a, a commodity name 143b, and a commodity unit price 143c in association with one another. The commodity master 143 is used for checkout processing performed by the POS terminal 113 (see FIG. 1). The commodity master 143 stores the commodity code 143a, size information 143d of the commodity 103 specified by the commodity code 143a, and display method information 143e indicating a display method for the commodity 103 in association with one another. The size information 143d includes the commodity width w, the commodity depth d, and the commodity height h of the commodities 103 (see FIG. 3 as well). The display method information 143e includes a display direction flag 143i as display direction information, an inversion flag 143j as inverted display information, and a stack flag 143k as stack information. The commodity master 143 plays roles of a commodity-size storing unit, a display-direction-information storing unit, an inverted-display-information storing unit, and a stack-information storing unit.

The display direction flag 1431 defines whether a display direction of the commodity 103 specified by the commodity code 143a is decided. When the display direction flag 143i is “0”, this indicates that the commodity 103 should be displayed with the commodity name indication 126 directed to the front direction. When the display direction flag 143i is “1”, this indicates that the commodity 103 may be displayed with the commodity name indication 126 directed to a direction other than the front direction.

The inversion flag 143j defines whether the commodity 103 specified by the commodity code 143a can be displayed in a laid state. When the inversion flag 143j is “0”, this indicates that the commodity 103 must not be displayed in a laid state with a side of the commodity 103 set in contact with the bottom surface of the display space 125. When the inversion flag 143j is “1”, this indicates that the commodity 103 may be displayed in a laid state.

The stack flag 143k defines whether the commodity 103 specified by the commodity code 143a can be displayed in a stacked state. When the stack flag 143k is “0”, this indicates that the commodity 103 must not be displayed in such a manner as to place another commodity 103 on the commodity 103. When the stack flag 143k is “1”, this indicates that the commodity 103 may be displayed in a stacked state.

The display shelf master 144 (FIG. 5B) stores a space code 144a for specifying the display spaces 125 and size information 144b of the display spaces 125 in association with each other. The space code 144a includes a shelf specifying sign 144c, a shelf level number 144d, and a shelf column number 144e. The size information 144b includes space width x, space depth y, and space height z indicating dimensions of the display space 125 specified by the space code 144a (see FIG. 2 as well).

The limit-number-of-displayed-commodities table 145 (FIG. 5C) stores a commodity code 145a, a space code 145b, and a limit number of displayed commodities 145c in association with one another. Like the space code explained above, the space code 145b includes a shelf specifying sign 145ba, a shelf level number 145bb, and a shelf column number 145bc. The limit number of displayed commodities 145c indicates a maximum number of the commodities 103 that can be displayed in the display space 125 specified by the space code 145b. The information processing unit 134 carries out limit-number-of-displayed-commodities calculation processing (FIG. 6). The information processing unit 134 stores the calculated limit number of displayed commodities 145c in the limit-number-of-displayed-commodities table 145. Further, the information processing unit 134 also carries out processing for deciding the limit number of displayed commodities (FIG. 8). The information processing unit 134 updates the limit number of displayed commodities 145c to a value desired by the store clerk 106 according to this decision processing.

One of application programs (not shown) included in the computer program 140 is an application program for editing contents of the database 142 and the commodity master 143. The store clerk 106 rewrites, when necessary, the contents of the database 142 and the commodity master 143 using this application program.

FIG. 6 is a flowchart of a flow of processing for calculating the limit number of displayed commodities. In the computer system 101, the CPU 131 of the server 117 executes the limit-number-of-displayed-commodities calculating program 141. The CPU 131 stays on standby until both a commodity code and a space code are input (Act 101). The store clerk 106 inputs a commodity code and a space code via the keyboard 137 according to an indication of an input screen displayed on the display 138. Alternatively, the store clerk 106 inputs a commodity code and a space code using the PDA terminal 112.

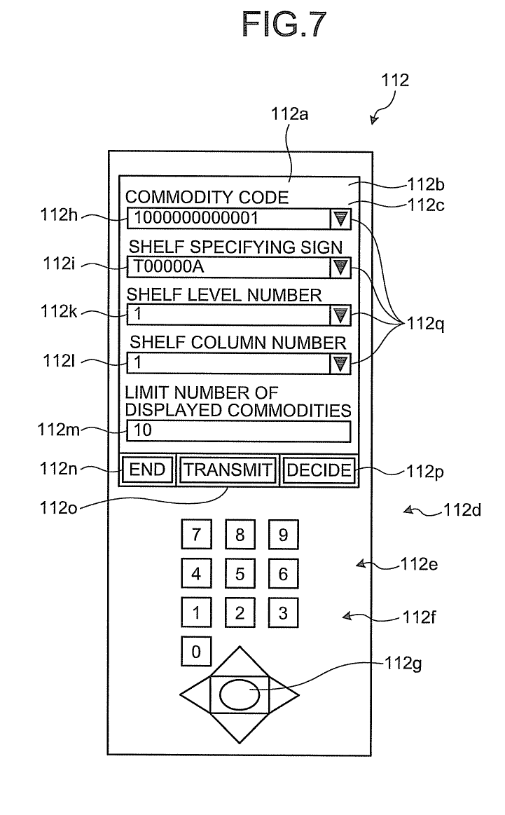

FIG. 7 is a schematic diagram of an example of an input screen displayed on an input screen 112a of the PDA terminal 112. The PDA terminal 112 includes a liquid crystal display 112b, a touch panel 112c laminated and arranged on the liquid crystal display 112b, and a keyboard 112d. The keyboard 112d includes a ten key 112e, a cursor key 112f, and an enter key 112g. The PDA terminal 112 performs radio communication with the server 117 via the radio access point 119. Therefore, the server 117 executes a computer program for executing data communication with the PDA terminal 112.

On the liquid crystal display 112b, the input screen 112a for inputting a commodity code and a space code is displayed. A control circuit (not shown) included in the PDA terminal 112 executes display control. The input screen 112a includes a commodity code input form 112h for inputting a commodity code, a shelf specifying sign input form 112i for inputting a shelf specifying sign, a shelf level number input form 112k for inputting a shelf level number, and a shelf column number input form 1121 for inputting a shelf column number. Pull-down buttons 112q for displaying selection items in a pull-down format are provided in right end areas of the input forms 112h to 1121. Further, the liquid crystal display 112b includes a limit-number-of-displayed-commodities display frame 112m for displaying a limit number of displayed commodities, an end button 112n for declaring the end of operation by the PDA terminal 112, a transmission button 112o for performing operation for transmitting a commodity code and a space code to the server 117, and a decision button 112p for deciding the limit number of displayed commodities displayed in the limit-number-of-displayed-commodities display frame 112m. The store clerk 106 performs input operation from the touch panel 112c or, the keyboard 112d using the PDA terminal 112. The store clerk 106 operates the transmission button 112o to transmit a commodity code and a space code (a shelf specifying sign, a shelf level number, and a shelf column number) displayed in the input forms 112h to 1121 to the server 117.

Referring back to FIG. 6, if the CPU 131 of the server 117 determines that both a commodity code and a space code are input (Y in Act 101), the CPU 131 acquires, from the commodity master 143 and the display shelf master 144, the size information 143d and the display method information 143e of the commodity 103 corresponding to the input commodity code and the size information 144b of the display space 125 corresponding to the input space code (a shelf specifying sign, a shelf level number, and a shelf column number). The CPU 131 stores the acquired information in the RAM 133 (Act 102).

Subsequently, the CPU 131 calculates, on the basis of the data acquired in Act 102, the number of displayed commodities by direction in the case in which the commodity 103 is displayed in the display space 125 (Act 103). More specifically, first, in Act 103, the CPU 131 divides the space width x by the commodity width w. The CPU 131 calculates an integer portion of a division result as a number of commodities in width direction X. In Act 103, the CPU 131 divides the space depth y by the commodity depth d. The CPU 131 calculates an integer portion of a division result as a number of commodities in depth direction Y. In Act 103, the CPU 131 divides the space height z by the commodity height h. The CPU 131 calculates an integer portion of a division result as a number of commodities in height direction Z.

Subsequently, the CPU 131 determines whether the stack flag 143k in the display method information 143e acquired in Act 102 is “1” (Act 104). In other words, in Act 104, the CPU 131 determines whether the commodity 103 can be displayed in a stacked state. If the stack flag 143k is “1” (Y in Act 104), the CPU 131 multiplies together the number of commodities in width direction X, the number of commodities in depth direction Y, and the number of commodities in height direction Z calculated in Act 103 to calculate a limit number of displayed commodities (Act 105). On the other hand, if the stack flag 143k is not “1” (N in Act 104), the CPU 131 multiplies together the number of commodities in width direction X and the number of commodities in depth direction Y calculated in Act 103 to calculate a limit number of displayed commodities (Act 106).

Subsequently, the CPU 131 determines whether limit numbers of displayed commodities are calculated for all display methods assumed on the basis of the display method information 143e (Act 107). Specifically, when the display direction flag 143i included in the display method information 143e is “1”, the CPU 131 interchanges a value of the commodity width w and a value of the commodity depth d (Act 108). When the inversion flag 143j included in the display method information 143e is “1”, the CPU 131 interchanges a value of the commodity height h and a value of the commodity width w (Act 109). The CPU 131 performs Act 108 and Act 109 as appropriate and returns to Act 103. The CPU 131 calculates a limit number of displayed commodities again. In Acts 103 to 109, the CPU 131 determines a combination of [a value for dividing the number of commodities in width direction X, a value for dividing the number of commodities in depth direction Y, and a value for dividing the number of commodities in height direction Z] as shown in Table 1 according to values of the display direction flag 143i and the inversion flag 143j.

TABLE 1

| | | COMBINATION OF |
|---|---|---|
| | | [VALUE FOR DIVIDING |
| DISPLAY | | X, VALUE FOR |
| DIRECTION | INVERSION | DIVIDING Y, AND |
| FLAG | FLAG | VALUE FOR DIVIDING Z] |
| 0 | 0 | [w, d, h] |
| 1 | 0 | [w, d, h], [d, w, h] |
| 0 | 1 | [w, d, h], [h, d, w] |
| 1 | 1 | [w, d, h], [d, w, h], [h, d, w], |
| | | [w, h, d], [d, h, w], [h, w, d] |

If the CPU 131 determines in Act 107 that limit numbers of displayed commodities are calculated for all the combinations shown in Table 1 (Y in Act 107), the CPU 131 adopts a largest one among limit numbers of displayed commodities calculated to that point (Act 110). The CPU 131 transmits the adopted limit number of displayed commodities to the PDA terminal 112. On the other hand, the PDA terminal 112 displays the limit number of displayed commodities received from the server 117 on the liquid crystal display 112b (Act 111). The CPU 131 ends a series of processing. In this embodiment, in Act 111, specifically, the CPU 131 causes the radio access point 119 to transmit, by radio, information concerning the adopted limit number of displayed commodities to the PDA terminal 112. As another form, the CPU 131 causes the radio access point 119 to transmit, by radio, information concerning a display direction of the commodity 103 in which a limit number of displayed commodities is maximized (i.e., the combination of [the value for dividing the number of commodities in width direction X, the value for dividing the number of commodities in depth direction Y, and the value for dividing the number of commodities in height direction Z]) together with the information concerning the limit number of displayed commodities. As still another form, in Act 111, the CPU 131 displays the limit number of displayed commodities on the display 138 of the server 117.

FIG. 8 is a flowchart of a flow of processing for deciding a limit number of displayed commodities. A control circuit (not shown) of the PDA terminal 112 displays the input screen 112a on the liquid crystal display 112b. The control circuit of the PDA terminal 112 repeatedly executes Acts 301 to 308 explained below.

First, the control circuit of the PDA terminal 112 stands by for operation of the transmission button 112o by the store clerk 106 (Act 301). If the control circuit of the PDA terminal 112 determines that the transmission button 112o is operated (Y in Act 301), as explained above, the control circuit transmits a commodity code and a space code to the server 117 (Act 302). On the other hand, the server 117 executes Acts 101 to 111 (FIG. 6) explained above.

Subsequently, if the control circuit of the PDA terminal 112 determines that the limit number of displayed commodities is received from the server 117 (Y in Act 303), the control circuit displays the received limit number of displayed commodities in the limit-number-of-displayed-commodities display frame 112m of the input screen 112a. When the control circuit of the PDA terminal 112 receives a display direction of the commodity 103 together with the limit number of displayed commodities, the control circuit also displays the display direction together with the limit number of displayed commodities.

Subsequently, if the control circuit of the PDA terminal 112 determines that correction operation for the limit number of displayed commodities displayed in the limit-number-of-displayed-commodities display frame 112m by the input operation from the touch panel 112c or the keyboard 112d is performed (Y in Act 305), the control circuit corrects a value of the limit number of displayed commodities in the limit-number-of-displayed-commodities display frame 112m to a value based on the correction operation. The limit number of displayed commodities calculated by the processing for calculating a limit number of displayed commodities (FIG. 6) is a maximum value based on the size information 143d of the commodity 103 stored in the commodity master 143 and the size information 144b of the display space 125 stored in the display shelf master 144. However, actually, in some case, sizes of the commodity 103 and the display shelf 109 are slightly different from the size information 143d and the size information 144b. In other case, the display space 125 is unexpectedly widened or narrowed. In such a case, the store clerk 106 can display, in the display space 125, the commodities 103 in a number different from the calculated limit number of displayed commodities. Therefore, in Acts 305 and 306, the control circuit of the PDA terminal 112 reflects, on a limit number of displayed commodities, the number of commodities 103 that can be actually displayed.

Subsequently, if the control circuit of the PDA terminal 112 determines that the decision button 112p is operated via the touch panel 112c or the keyboard 112d (Y in Act 307), the control circuit transmits, by radio, the limit number of displayed commodities input in the limit-number-of-displayed-commodities display frame 112m to the server 117 together with the commodity code and the space code (Act 308). The CPU 131 of the server 117 stands by for reception of information such as the decided limit number of displayed commodities from the PDA terminal 112 according to the computer program 140 stored in the hard disk 136 (Act 201). If the CPU 131 of the server 117 receives the information such as the decided limit number of displayed commodities (Y in Act 201), the CPU 131 stores the received information such as the commodity code, the space code, and the decided limit number of displayed commodities in the limit-number-of-displayed-commodities table 145 in association with one another. As a result, the limit number of displayed commodities of the limit-number-of-displayed-commodities table 145 is updated.

The computer system 101 according to this embodiment explained above easily calculates a maximum number of commodities that can be displayed on a display shelf (a limit number of displayed commodities). In the supermarket 102 in which the computer system 101 is installed, the computer system 101 makes display work efficient.

First, the store clerk 106 inputs size information (commodity width, commodity depth, and commodity height) of the commodities 103 and size information (space width, space depth, and space height) of the display spaces 125 of the display shelves 109 via the keyboard 137 and the display 138 included in the server 117. The CPU 131 of the server 117 stores these kinds of information in the commodity master 143 and the display shelf master 144. The store clerk 106 also inputs, for each of the commodities 103, information concerning the commodity 103 can be displayed to be directed in a direction other than the front, whether the commodity 103 can be displayed in a laid state, and whether the commodity 103 can be displayed in a stacked state. The CPU 131 of the server 117 reflects these kinds of information on the commodity master 143 as the display method information 143e (the display direction flag 143i, the inversion flag 143j, and the stack flag 143k). The size information and the display method information of the commodity 103 is, for example, a value of a result obtained by the store clerk 106 directly measuring an outer shape of the commodity 103 or a value presented by a manufacturer of the commodity 103. The size information of the display space 125 is a value of a result obtained by the store clerk 106 directly measuring dimensions of the display space 125 or a value presented by a manufacturer of the display shelf 109.

The store clerk 106 inputs a commodity code and a space code (a shelf specifying sign, a shelf level number, and a shelf column number) from the touch panel 112c or the keyboard 112d of the PDA terminal 112. The store clerk 106 performs operation for transmitting this information to the server 117. Thereafter, the control circuit of the PDA terminal 112 displays a value of a limit number of displayed commodities in the limit-number-of-displayed-commodities display frame 112m of the liquid crystal display 112b of the PDA terminal 112. The value of the limit number of displayed commodities is a value calculated by the server 117 on the basis of a size of the commodity 103 specified by the commodity code and a size of the display space 125 specified by the space code. Subsequently, when the store clerk 106 operates the decision button 112p displayed on the liquid crystal display 112b of the PDA terminal 112, according to the operation, the CPU 131 of the server 117 stores the limit number of displayed commodities in the limit-number-of-displayed-commodities table 145 in association with the commodity code and the space code.

It is assumed that a system configured to total the number of commodities 103 displayed on the display shelf 109 such as the electronic inventory tag system disclosed in JP-A-2007-206745 is installed in the supermarket 102. In this case, what matters is the number of commodities 103 that the store clerk 106 should carry to the display shelf 109 when the store clerk 106 performs work for supplying the commodities 103. In the computer system 101 according to this embodiment, the server 117 calculates a maximum number of commodities 103 that can be displayed in the display space 125 on the display shelf 109 (a limit number of displayed commodities). Therefore, the store clerk 106 only has to carry the commodities 103 in a number obtained by subtracting the remaining number of the commodities 103 on the display shelf 109, which is grasped by the system such as the electronic inventory tag system, from the calculated limit number of displayed commodities. Consequently, the store clerk 106 can display an enough number of commodities 103 on the display shelf 109. In some case, depending on the shape of the commodity 103 or the shape of the display space 125 on the display shelf 109, there is a difference between the calculated limit number of displayed commodities and an actual maximum number of commodities 103 that can be displayed on the display shelf 109. When the store clerk 106 recognizes the difference, the store clerk 106 only has to operate the PDA terminal 112 to correct a value of the limit number of displayed commodities displayed in the limit-number-of-displayed-commodities display frame 112m. Then, the store clerk 106 only has to transmit information such as the decided limit number of displayed commodities to the server 117. Consequently, when the store clerk 106 performs work for supplying the commodities 103 to the display shelf 109 again, the store clerk 106 can surely display the commodities 103 full on the display shelf 109. As a result, a frequency of the supply work by the clerk 106 is reduced. Further, unnecessary work for returning the commodities 103 left during the supply work to the warehouse is also reduced.

Further effects and modifications can be easily derived by those skilled in the art. Therefore, a wider aspect of the present invention is not limited by the specific details and the representative embodiment represented and described above. Therefore, various modifications are possible without departing from the spirit or the scope of the general concept of the invention defined by the appended claims and their equivalents.

What is claimed is:

1. A computer system comprising:
an input unit for inputting information;
a display unit for displaying the information;
a space-size storing unit for storing, in association with a space code for specifying a display space, size information of the display space;
a commodity-size storing unit for storing, in association with a commodity code for specifying a commodity, size information of the commodity; and
an information processing unit configured to execute:
processing for dividing space width of a display space, the space width of a display space being specified by a space code input from the input unit and being acquired from the space-size storing unit, by commodity width of a commodity, the commodity width of a commodity being specified by a commodity code input from the input unit and being acquired from the commodity-size storing unit, to calculate a width direction number of commodities that can be displayed in a width direction of the display space;
processing for dividing space depth of the display space, the space depth of the display space being specified by the input space code and being acquired from the space-size storing unit, by commodity depth of the commodity, the commodity depth of the commodity being specified by the input commodity code and being acquired from the commodity-size storing unit, to calculate a depth direction number of commodities that can be displayed in a depth direction of the display space;
processing for multiplying together the width direction number of commodities and the depth direction number of commodities to calculate a limit number of displayed commodities; and
processing for displaying the limit number of displayed commodities on the display unit.

2. The system according to claim 1, further comprising a display-direction-information storing unit for storing, in association with the commodity code, display direction information for defining whether a display direction of the commodity specified by the commodity code is decided, wherein
the information processing unit executes:
processing for acquiring display direction information corresponding to the input commodity code with reference to the display-direction-information storing unit; and
processing for interchanging, when it is determined that the acquired display direction information indicates that a display direction of the commodity is not decided, the commodity width and the commodity depth to calculate the width direction number of commodities and the depth direction number of commodities.

3. The system according to claim 1, further comprising an inverted-display-information storing unit for storing, in association with the commodity code, inverted display information for defining whether the commodity specified by the commodity code can be displayed in a laid state, wherein
the information processing unit executes:
processing for acquiring inverted display information corresponding to the input commodity code with reference to the inverted-display-information storing unit; and
processing for interchanging, when it is determined that the acquired inverted-display information indicates that the commodity can be displayed in the laid state, the commodity width and commodity height of the commodity specified by the input commodity code and acquired from the commodity-size storing unit to calculate the width direction number of commodities and the depth direction number of commodities.

4. The system according to claim 1, further comprising a stack-information storing unit for storing, in association with the commodity code, stack information for defining whether the commodity specified by the commodity code can be displayed in a stacked state, wherein
the information processing unit executes:
processing for dividing space height of the display space, the space height of the display space being specified by the input space code and being acquired from the space-size storing unit, by commodity height of the commodity, the commodity height of the commodity being specified by the input commodity code and being acquired from the commodity-size storing unit, to calculate a height direction number of commodities that can be displayed in a height direction of the display space; and
as the processing for calculating the number of displayed commodities, processing for acquiring stack information corresponding to the input commodity code with reference to the stack-information storing unit; and processing for multiplying together the width direction number of commodities, the depth direction number of commodities, and the height direction number of commodities to calculate a limit number of displayed commodities when it is determined that the acquired stack information indicates that the commodity can be displayed in a stacked state.

5. The system according to claim 1, wherein the information processing unit executes:
processing for storing the calculated limit number of displayed commodities in a storing unit; and
processing for updating the limit number of displayed commodities stored in the storing unit to the limit number of displayed commodities input from the input unit.

6. A method carried out by a computer system, the method comprising:
storing, in association with a space code for specifying a display space, size information of the display space in a space-size storing unit;
storing, in association with a commodity code for specifying a commodity, size information of the commodity in a commodity-size storing unit;
dividing space width of a display space, the space width a display space being specified by a space code input from an input unit and being acquired from the space-size storing unit, by commodity width of a commodity, the commodity width of a commodity being specified by a commodity code input from the input unit and being acquired from the commodity-size storing unit, to calculate a width direction number of commodities that can be displayed in a width direction of the display space;
dividing space depth of the display space, the space depth of the display space being specified by the input space code and being acquired from the space-size storing unit, by commodity depth of the commodity, the commodity depth of the commodity being specified by the input commodity code and being acquired from the commodity-size storing unit, to calculate a depth direction number of commodities that can be displayed in a depth direction of the display space; and
multiplying together the width direction number of commodities and the depth direction number of commodities to calculate a limit number of displayed commodities.

7. The method according to claim 6, further comprising:
storing, in association with the commodity code, in a display-direction-information storing unit, display direction information for defining whether a display direction of the commodity specified by the commodity code is decided;
acquiring display direction information corresponding to the input commodity code with reference to the display-direction-information storing unit; and
interchanging, when it is determined that the acquired display direction information indicates that a display direction of the commodity is not decided, the commodity width and the commodity depth to calculate the width direction number of commodities and the depth direction number of commodities.

8. The method according to claim 6, further comprising:
storing, in association with the commodity code, in an inverted-display-information storing unit, inverted display information for defining whether the commodity specified by the commodity code can be displayed in a laid state;
acquiring inverted display information corresponding to the input commodity code with reference to the inverted-display-information storing unit; and
interchanging, when it is determined that the acquired inverted-display information indicates that the commodity can be displayed in the laid state, the commodity width and commodity height of the commodity specified by the input commodity code and acquired from the commodity-size storing unit to calculate the width direction number of commodities and the depth direction number of commodities.

9. The method according to claim 6, further comprising:
storing, in association with the commodity code, in a stack-information storing unit, stack information for defining whether the commodity specified by the commodity code can be displayed in a stacked state;
dividing space height of the display space, the space height of the display space being specified by the input space code and being acquired from the space-size storing unit, by commodity height of the commodity, the commodity height of the commodity being specified by the input commodity code and being acquired from the commodity-size storing unit, to calculate a height direction number of commodities that can be displayed in a height direction of the display space; and
as the method of calculating a limit number of displayed commodities, acquiring stack information corresponding to the input commodity code with reference to the stack-information storing unit; and multiplying together the width direction number of commodities, the depth direction number of commodities, and the height direction number of commodities to calculate a limit number of displayed commodities when it is determined that the acquired stack information indicates that the commodity can be displayed in a stacked state.

10. The method according to claim 6, further comprising:
storing the calculated limit number of displayed commodities in a storing unit; and
updating the limit number of displayed commodities stored in the storing unit to the limit number of displayed commodities input from the input unit.
